(19) United States
(12) Patent Application Publication
(10) Pub. No.: US 2014/0085632 A1
(43) Pub. Date: Mar. 27, 2014

(54) Pixel-Shifting Spectrometer on Chip

(71) Applicants: Kyle Preston, Groton, NY (US); Arthur Nitkowski, Ithaca, NY (US)

(72) Inventors: Kyle Preston, Groton, NY (US); Arthur Nitkowski, Ithaca, NY (US)

(21) Appl. No.: 14/035,288

(22) Filed: Sep. 24, 2013

Related U.S. Application Data
(60) Provisional application No. 61/704,847, filed on Sep. 24, 2012.

(51) Int. Cl. G01J 3/28

(52) U.S. Cl. CPC G01J 3/2823
USPC 356/326

(57) ABSTRACT

Various embodiments of apparatuses, systems and methods are described herein for implementing pixel-shifting or an interpixel shift to increase the effective dispersion and effective spectral resolution of a spectrometer in a manner which is faster, less complicated and more robust compared to conventional techniques that employ mechanical motion to implement pixel-shifting in a spectrometer that uses free space optical components.

### CROSS REFERENCE TO RELATED APPLICATION

This application claims the benefit of U.S. Provisional Application No. 61/704,847 filed on Sep. 24, 2012 and the contents of Application No. 61/704,847 are hereby incorporated by reference in their entirely.

### FIELD

The various embodiments described herein generally relate to an apparatus and method for implementing pixel-shifting for a spectrometer.

### BACKGROUND

An optical spectrometer is a system that is used to measure the spectral components of an optical signal. In a general case, dispersive spectrometers use a dispersive element such as a diffraction grating to spatially distribute the spectral components of the optical signal. In other words, a spatially dispersed spectrum is generated by the dispersive element. The dispersed spectrum of the optical signal is then sampled and measured by a linear array of detectors (e.g. a detection array) to provide a set of output samples.

### SUMMARY OF VARIOUS EMBODIMENTS

In one broad aspect, at least one embodiment described herein provides a spectrometer comprising a dispersive element configured to generate a plurality of spatially separated spectral components from a received optical signal, the dispersive element being fabricated on a chip; a detector array coupled to the dispersive element to capture a plurality of narrowband optical signals from the plurality of spatially separated spectral components and generate output samples thereof; and a tuning element configured to change a property of the spectrometer in different states of operation in order to shift the plurality of narrowband optical signals in wavelength to increase an effective number of output samples generated by the detector array when the spectrometer is used in more than one state of operation.

In at least some embodiments, the tuning element may be a heating element that creates a refractive index shift in the dispersive element by changing a temperature of the dispersive element by an appropriate amount to achieve a desired wavelength shift.

In at least some embodiments, the heating element may comprise a localized integrated heating element or a thermoelectric cooler.

In at least some embodiments, the tuning element may be configured to apply one of an electric field, a magnetic field or a change in electron-hole concentration to the dispersive element to create a refractive index shift in the dispersive element in order to shift the plurality of narrowband optical signals in wavelength.

In at least some embodiments, the tuning element may be configured to change a local refractive index of a cladding around the dispersive element to create a refractive index shift in the dispersive element in order to shift the plurality of narrowband optical signals in wavelength.

In at least some embodiments, the tuning element may comprise a switch element having an input port and at least two output ports, the switch element being controlled to transmit a received optical signal to the dispersive element through one of the output ports; wherein, in use, the output port of the switch element that transmits light to the dispersive element may be switched in at least one state of operation in order to achieve the wavelength shift of the plurality of narrowband optical signals.

In at least some embodiments, the at least two output ports may be positioned along an input to the dispersive element to have a desired distance there between to achieve the wavelength shift.

In at least some embodiments, the at least two output ports may be positioned along an input focal curve of the dispersive element.

In at least some embodiments, the tuning element may comprise a bank of output switch elements having several input ports and one output port, the bank of output switch elements being coupled to the dispersive element to capture a plurality of narrowband optical signals from the plurality of spatially separated spectral components, each output switch element being controlled to transmit a narrowband optical signal in one of the input ports to the detector array through the output port and in use, the input port of at least one output switch element selected to transmit light to the detector array is switched in at least one state of operation in order to achieve the wavelength shift of the plurality of narrowband optical signals.

In at least some embodiments, the bank of output switch elements may be located along an output of the dispersive element so that adjacent outputs of the dispersive element that are provided to a common switch element are offset by the wavelength shift.

In at least some embodiments, the bank of output switch elements may be located along an output focal curve of the dispersive element.

In at least some embodiments, the bank of output switch elements may comprise a series of M×1 switches which select between outputs from the dispersive element offset by a desired wavelength shift Δλ.

In at least some embodiments, each series of output switch elements may be switched in the same manner during different states of operation.

In at least some embodiments, each series of output switch elements may be switched in various combinations to switch all or some of the narrowband optical signals generated by the dispersive element.

In at least some embodiments, the tuning element comprises at least one switch element comprising at least one of an on-chip MEMS switch, an off-chip fiber-optic switch, or an interferometer-based device that can be controlled to have a refractive index change by using the material thermo-optic effect, an electric field, a magnetic field, or a change in electron-hole concentration, the interferometer-based device being located on-chip, off-chip, or on a different chip with respect to the dispersive element.

In another broad aspect, at least one embodiment described herein provides an optical measurement system comprising a tunable light source comprising a frequency comb configured to provide an optical signal having a comb of discrete wavelengths; a splitter coupled to the tunable light source, the splitter configured to split the optical signal into first and second portions; a reference arm coupled to the splitter to receive the first portion of the optical signal and provide a reference optical signal back to the splitter; a sample arm coupled to the splitter to receive the second portion of the optical signal and provide a sample optical signal to the splitter; a spectrometer coupled to the splitter to receive an interference signal resulting from a combination of the reference optical signal and the sample optical signal and generate output samples representative of the spectrum of the interference signal, at least a dispersive element of the spectrometer being located on a chip; and a computing device coupled to the spectrometer to receive the output samples and generate an inverse Fourier transform of the interference signal based on the output samples, wherein, in use, the measurement system is operated in a first state and at least one additional state by configuring the tunable light source to alter the frequency comb to provide a shift in wavelength in the output of the spectrometer thereby increasing an effective number of output samples generated by the spectrometer when the spectrometer is used in more than one state of operation.

In at least some embodiments, the tunable light source may be configurable to alter the frequency comb by using refractive index tuning.

In at least some embodiments, the refractive index tuning may be accomplished by applying one of a temperature change, an electric field, a magnetic field or a change in electron-hole concentration to the tunable light source.

In at least some embodiments, the dispersive element may be one of an Arrayed Waveguide Grating (AWG) or a Planar Concave Grating (PCG).

In at least some embodiments, at least one of calibration and a feedback signal may be used to control the shift in wavelength.

In another broad aspect, at least one embodiment described herein provides a method of increasing output data samples from a spectrometer, wherein the method comprises configuring the spectrometer to operate in a first state by configuring a tuning element to change a property of the spectrometer, the spectrometer being fabricated on a chip; obtaining a first data set corresponding to the measurement of a spectrum of a first input optical signal during the first state; configuring the spectrometer to operate in a second state in which one of input optical signals to the spectrometer or output optical signals from the spectrometer are shifted in wavelength compared to the first state; obtaining a second data set corresponding to the measurement of a spectrum of a second input optical signal during the second state; and generating a final data set from the data sets obtained during the states.

In at least some embodiments, the spectrometer may be used in an Optical Coherence Tomography (OCT) system and the method further comprises processing the final data set to obtain an OCT image.

In at least some embodiments, the input optical signals to the spectrometer may be shifted in wavelength by using a tunable light source for the OCT system and altering a frequency comb of the tunable light source in at least one of the states of operation.

In at least some embodiments, the input optical signals to the spectrometer may be shifted in wavelength by using a switch element that is switchable to provide one of two input optical signals to a dispersive element of the spectrometer and switching the switch element in at least one of the states of operation.

In at least some embodiments, the output optical signals from the spectrometer may be shifted in wavelength by changing a refractive index of a dispersive element of the spectrometer in at least one of the states of operation.

In at least some embodiments, the output optical signals from the spectrometer may be shifted in wavelength by using a bank of a series of output switch elements each having several input ports that are switchable and coupled to a dispersive element of the spectrometer and switching the input ports on at least one output switch element in at least one of the states of operation.

In at least some embodiments, the method may further comprise using at least one of calibration and a feedback signal to control the shift in wavelength.

In another broad aspect, at least one embodiment described herein provides a spectrometer comprising a switch element having an input port and at least two output ports, the switch element being controlled to transmit a received optical signal to one of the output switch ports; a dispersive element coupled to the switch element, the dispersive element being configured to generate a plurality of spatially separated spectral components from an optical signal received from the switch element, the dispersive element being fabricated on a chip; and a detector array coupled to the dispersive element to capture a plurality of narrowband optical signals from the plurality of spatially separated spectral components and generate output samples thereof, wherein, in use, the output port of the switch element that transmits light to the dispersive element is switched in at least one state of operation to achieve a wavelength shift in the plurality of narrowband optical signals thereby increasing an effective number of output samples generated by the detector array.

In another broad aspect, at least one embodiment described herein provides a spectrometer comprising a dispersive element configured to generate a plurality of spatially separated spectral components from a received optical signal, the dispersive element being fabricated on a chip; a bank of output switch elements having several input ports and one output port, the bank of output switch elements being coupled to the dispersive element to capture a plurality of narrowband optical signals from the plurality of spatially separated spectral components, each output switch element being controlled to transmit a narrowband optical signal in one of the input ports to the output port; and a detector array coupled to the bank of output switch elements to receive the plurality of narrowband optical signals and generate output samples, wherein, in use, the input port of at least one output switch element selected to transmit light to the detector array is switched in at least one state of operation to achieve a wavelength shift in the plurality of narrowband optical signals thereby increasing an effective number of output samples generated by the detector array.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a block diagram of an example embodiment of a spectrometer;

FIGS. 2A and 2B are example graphs illustrating the effect of pixel-shifting in a wavelength spectrum;

FIGS. 3A and 3B are schematic diagrams of a portion of an example embodiment of a spectrometer in State 1 and State 2 respectively to achieve pixel-shifting;

FIG. 3C shows an experimental result of enhanced OCT imaging depth using pixel-shifting with the thermo-optic technique shown in FIGS. 3A and 3B;

FIGS. 4A and 4B are schematic diagrams of a portion of an example embodiment of a spectrometer that is provided with one of two inputs to achieve State 1 and State 2 to achieve pixel-shifting;

FIG. 5 is a schematic diagram of a portion of an example embodiment of a spectrometer that uses a bank of output switch elements after the dispersive element to achieve State 1 and State 2 to achieve pixel-shifting;

FIG. 6 is a flowchart of an example embodiment of a method to implement pixel-shifting in a spectrometer;

FIG. 7 is a flowchart of an example embodiment of a calibration method that can be used for a pixel-shifting spectrometer;

FIGS. 8A-8D show the calibration method of FIG. 7 graphically;

FIG. 9 is a schematic diagram of a portion of an example embodiment of a spectrometer in which several optical ports are used to monitor and detect an optical signal with a known reference wavelength which is used as a feedback signal for monitoring pixel-shifting;

FIG. 10 is a block diagram of an example embodiment of an SD-OCT system that can use one of the pixel-shifting spectrometers described herein;

FIGS. 11A and 11B show example graphs illustrating the operation of a tunable light source and a fixed spectrometer to achieve pixel-shifting; and

FIG. 12 is a flowchart of an example embodiment of a method to implement pixel-shifting in an OCT system.

### DETAILED DESCRIPTION OF THE EMBODIMENTS

Various apparatuses or processes will be described below to provide an example of an embodiment of each claimed subject matter. No embodiment described below limits any claimed subject matter and any claimed subject matter may cover processes or apparatuses that differ from those described below. The claimed subject matter is not limited to apparatuses or processes having all of the features of any one apparatus or process described below or to features common to multiple or all of the apparatuses or processes described below. It is possible that an apparatus or process described below is not an embodiment of any claimed subject matter. Any subject matter disclosed in an apparatus or process described herein that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein in any way, but rather as merely describing the implementation of various embodiments as described.

The terms or phrases “an embodiment,” “embodiment,” “embodiments,” “the embodiment”, “the embodiments”, “one or more embodiments”, “some embodiments”, “at least one embodiment”, “at least some embodiments” and “one embodiment” mean “one or more (but not all) embodiments of the present subject matter”, unless expressly specified otherwise.

The terms “including,” “comprising” and variations thereof mean “including but not limited to”, unless expressly specified otherwise. A listing of items does not imply that any or all of the items are mutually exclusive, unless expressly specified otherwise.

It should also be noted that the terms coupled or coupling as used herein can have several different meanings depending in the context in which these terms are used. For example, the terms coupled or coupling can have a mechanical, electrical or optical, connotation. For example, depending on the context, the terms coupled or coupling indicate that two elements or devices can be physically, electrically or optically connected to one another or connected to one another through one or more intermediate elements or devices via a physical, an electrical or an optical element such as, but not limited to a wire, a fiber optic cable or a waveguide or another integrated circuit structure, for example.

It should be noted that terms of degree such as “substantially”, “about” and “approximately” as used herein mean a reasonable amount of deviation of the modified term such that the end result is not significantly changed. These terms of degree should be construed as including a deviation of up to a certain amount of the modified term if this deviation would not negate the meaning of the term it modifies.

Furthermore, the recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about.” The term “about” means a deviation of up to plus or minus a certain amount of the number to which reference is being made without negating the meaning of the term it modifies.

Furthermore, in the following passages, different aspects of the embodiments are defined in more detail. Each aspect so defined may be combined with any other aspect or aspects unless clearly indicated to the contrary. In particular, any feature indicated as being preferred or advantageous may be combined with at least one other feature or features indicated as being preferred or advantageous.

The various embodiments described herein are generally related to an optical spectrometer. An optical spectrometer is a tool that is used to analyze the composition of a material or a substance based on its interaction with light. The material can be analyzed by observing how it transmits, reflects, absorbs, or re-emits light as a function of wavelength. This information can reveal the type of atoms and molecules present in a solid, liquid, or gas. Example applications include chemical analysis, quality control, remote sensing, and astronomy.

More particularly, the various embodiments described herein are related to implementing pixel-shifting or an interpixel shift to increase the effective dispersion and effective spectral resolution of a spectrometer in a manner which is faster, less complicated and more robust compared to conventional techniques that employ mechanical motion to implement pixel-shifting in a spectrometer that uses free space optical components.

The pixel-shifting embodiments described herein are useful for any application of an optical spectrometer because it doubles, triples, or further increases, as the case may be, the effective dispersion or resolution of the spectrometer, allowing sharper features to be observed in the spectrum of an input optical signal. Alternatively, the number of detector elements in the spectrometer can by reduced while maintaining the same dispersion or resolution.

One specific use of an optical spectrometer is to record data in an optical measurement system such as a Spectral-Domain Optical Coherence Tomography (SD-OCT) system, where the amplitude of spectral fringes with different frequency components corresponds to the reflectivity of a sample versus depth in the sample. In SD-OCT, an inverse Fourier transform is performed on the data set measured by the spectrometer in order to generate an SD-OCT image of reflectivity versus depth in the sample. The pixel-shifting embodiments described herein are useful in this application because increasing the dispersion or resolution of the spectrometer increases the imaging depth into the sample. Accordingly, the SD-OCT system can obtain high-resolution, cross-sectional images (i.e. SD-OCT images) of various samples such as, but not limited to, biological tissue for ophthalmic, dermatologic, or cardiovascular applications, and the imaging depth of the SD-OCT image can be increased by using at least one of the various pixel-shifting embodiments described herein. Other samples could include materials and devices for non-medical applications such as non-destructive testing or quality control, for example.

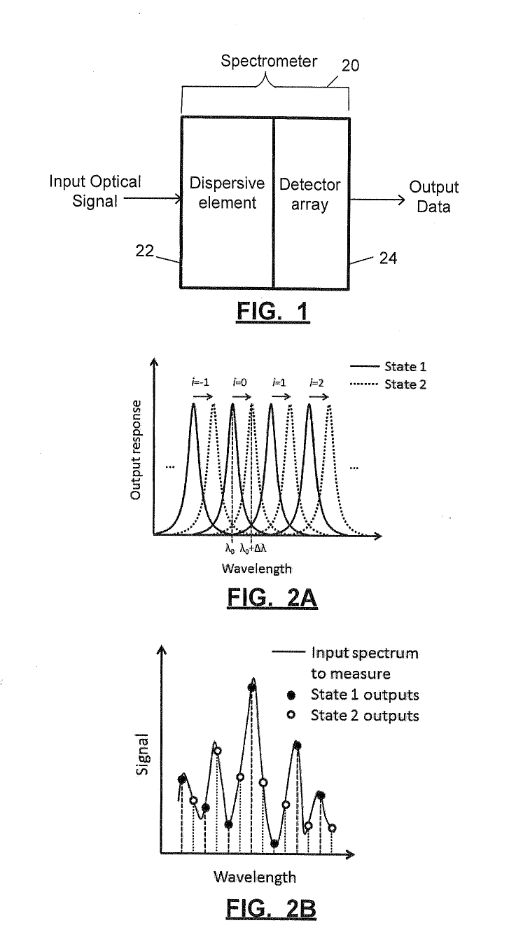

Referring now to FIG. 1, shown therein is an example embodiment of a spectrometer 20. The spectrometer 20 can measure data containing spectral information of an input optical signal as a function of wavelength. The measured data is then typically sent to a computing device where the data is analyzed, which may include generating an image.

In general, the spectrometer 20 comprises a dispersive element 22 and a detector array 24. The spectrometer 20 is implemented such that one or more components are integrated on a planar substrate (i.e. on an integrated chip). In some cases, all of the components may be integrated on the chip. In other cases, not all of the components need be located on the same chip. However, at least the dispersive element 22 is preferably located on-chip.

The dispersive element 22 receives the input optical signal and generates a plurality of spatially separated spectral components which form a dispersed spectrum along an output of the dispersive element 22 and are representative of the spectrum of the input optical signal. In some embodiments, the plurality of spatially separated spectral components is generated to form a dispersed spectrum along an output focal curve of the dispersive element 22. In general, the dispersive element 22 can be implemented by an Arrayed Waveguide Grating (AWG) or a Planar Concave Grating (PCG), for example.

The detector array 24 is an array of detector elements such as, but not limited to, surface-illuminated detector pixels or integrated waveguide photodetectors, that are arranged to capture and measure a plurality of narrowband optical signals from the plurality of spatially separated spectral components. Typically, the detector elements are linearly arranged to provide a linearly spaced array of pixels. It should be understood that the detector array 24 further comprises readout electronics (not shown) that are used to convert the signals measured by the detector elements (representing the measured data) into a suitable output data format that can be used by a computing device. In some embodiments, the readout electronics include a Field Programmable Gate Array or a microcontroller that provides clock and control signals to the detector elements in order to read the measured data from the detector elements and then format the measured data using a suitable output data format. For example, the output data format can be a USB format so that a USB connection can be used between the detector array 24 and a computing device. In some embodiments, another format can be used that is suitable for a Camera Link or a Gigabit Ethernet connection. In some embodiments, if the detector elements generate output analog signals, then the readout electronics also include a suitable number of analog to digital converters with a suitable number of channels. Accordingly, the detector array 24 provides measured data that corresponds to a plurality of narrowband optical signals. In general, the narrowband optical signals are captured such that the center wavelengths of these narrowband optical signals are linearly spaced in wavelength, however this may be changed in alternative embodiments so that the plurality of narrowband optical signals are linearly spaced in wavenumber.

In some embodiments, the spectrometer 20 further comprises an array of waveguides 23 (see FIGS. 1, 3A, 3B, 4A, 4B and 5) that are arranged for capturing the plurality of narrowband optical signals and transmitting them to the detector array 24. For example, when the detector array 24 comprises a linear array of detector elements the output ports of the waveguides are arranged with a linear pitch to interface with the detector array 24. The waveguides can be arranged such that the center wavelengths of each narrowband signal are equally spaced apart from one another in terms of wavelength. Other arrangements for the array of waveguides 23 may be used in alternative embodiments such that the center wavelengths of each narrowband signal are equally spaced apart from one another in terms of wavenumber as is described in U.S. Application No. 61/704,890.

When the spectrometer 20 is utilized in an SD-OCT system, several parameters of OCT images that can be obtained using the spectrometer 20 are directly related to the specifications of the spectrometer 20. For example, the maximum imaging depth (zₘₐₓ) allowed by Nyquist theory is inversely related to the dispersion, or output channel spacing (δλ) of the spectrometer 20 in units of nm/pixel as shown in equation 1.

$${z}_{max} = \frac{{λ}_{0}^{2}}{4 n δ λ} \qquad ( 1 )$$

In equation 1, λ₀ is the center wavelength and n is the refractive index of the sample being interrogated or examined. Equation 1 can also be written in another form as shown in equation 2.

$${z}_{max} = \frac{{λ}_{0}^{2}}{4 n} \frac{N}{Δ {λ}_{spec}} \qquad ( 2 )$$

In equation 2, Δλ_{spec} is the total bandwidth of the spectrometer 20 and N is the number of detector pixels or output channels.

Based on equations 1 and 2, it can be seen that in order to maximize the imaging depth zₘₐₓ, it is desirable to design the spectrometer 20 such that it has a minimal channel spacing δλ or a maximal number of spectral samples N within a given bandwidth Δλ_{spec}. Correspondingly, when a spectrometer 20 is designed for applications other than SD-OCT, it can be desirable to improve the dispersion or resolution in order to observe narrower spectral features from the input light signal.

In general, it is difficult to increase the number of outputs N to an arbitrarily high number due to practical constraints such as the number of pixels that are available in the detector array 24. However, it is possible to increase the effective number of sample outputs N by:
1. making a first measurement;
2. varying a parameter or a property of the spectrometer such that the spatially separated spectral components of the optical signal that are sent to the detector array 24 are shifted by a distance that is equal to a fraction of a pixel, such as, but not limited to, a distance of half a pixel, for example;
3. making a second measurement; and
4. combining data from the first and second measurements.
   This technique is known as a pixel-shifting technique or an interpixel shifting technique. Several example embodiments are described herein which implement the pixel-shifting technique to increase the effective dispersion and effective spectral resolution of a spectrometer in a manner which is faster, less complicated and more robust compared to conventional techniques that employ mechanical motion to implement pixel-shifting in a spectrometer that uses free space optical components.

Referring now to FIGS. 2A and 2B, shown therein are example graphs illustrating the concept of pixel-shifting in which the input optical signal is broadband and the spectrometer 20 is tunable such that its outputs or transfer functions can be shifted with respect to wavelength.

In particular, FIG. 2A shows the spectral transmission plots for a first state (i.e. State 1) and a second state (i.e. State 2). Each solid curve shows the transmission response for an output of the spectrometer 20 in State 1, with outputs numbered by i. In particular, each curve represents the output filter response of one channel of the spectrometer 20. The outputs of the spectrometer 20 are then shifted in State 2, represented by the dotted curves.

FIG. 2B shows the wavelengths that are sampled in State 1 and State 2 as solid and open dots respectively. In particular, FIG. 2B shows that there is an increase in the effective dispersion by a factor of two (other factors may be achieved in other embodiments as described herein). This increase in the effective dispersion will increase the effective spectral resolution by up to a factor of 2. This increased resolution is helpful for analyzing high-frequency components of the input optical signal's spectrum. For the SD-OCT application described previously, in general, an increase in the number of samples by a given factor generally corresponds to the maximum possible increase in imaging depth.

Example embodiments which can achieve the change from State 1 to State 2 are shown and described herein that use a dispersive spectrometer in which at least the dispersive element is integrated on a planar substrate (i.e. on a chip). Two examples of such dispersive spectrometers are Arrayed Waveguide Gratings (AWG) and Planar Concave Gratings (PCG). Accordingly, the following figures are representations of a spectrometer that may be implemented using AWGs or PCGs. However, in alternative embodiments other types of spectrometers can be used such as, but not limited to arrayed Mach-Zehnder interferometers and cascaded microresonators, for example.

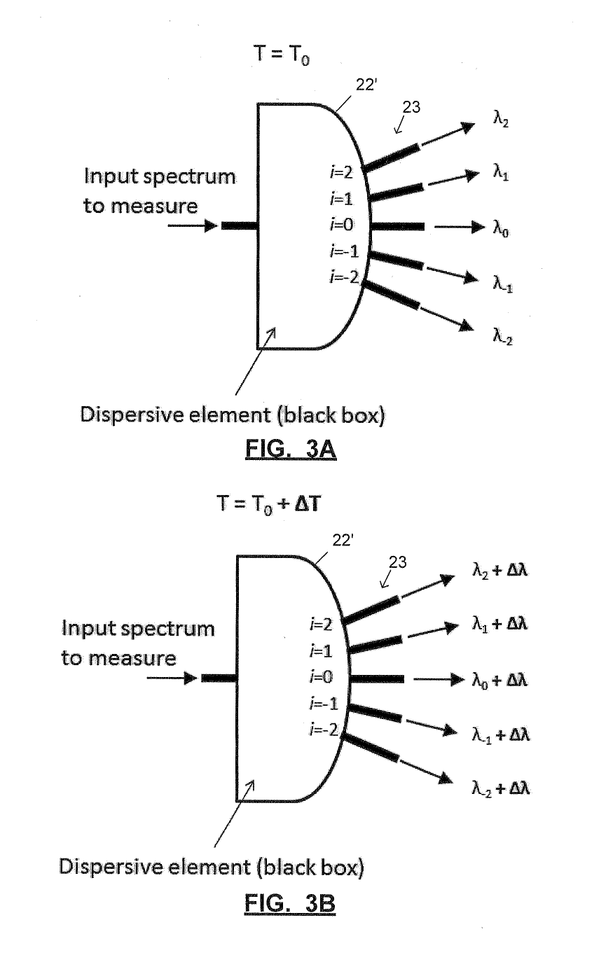

Referring now to FIGS. 3A and 3B, shown therein are schematic diagrams of a portion of an example embodiment of a spectrometer including a dispersive element 22′ in State 1 and State 2 respectively to achieve pixel-shifting. The change from State 1 to State 2 is achieved by using a tuning element to change or shift the refractive index of the material comprising the dispersive element 22′. In this example embodiment, the refractive index shift Δλ is obtained by changing the starting temperature T=T_{O} by an appropriate amount ΔT to T_{O}+ΔT and using the material thermo-optic effect. The temperature change can be implemented such that it affects a local portion of the chip, upon which the dispersive element is located, by using a localized integrated heating element such as a thin-film resistor as the tuning element, for example. Alternatively, the temperature change can be implemented such that it is global and affects the entire chip by using a thermoelectric cooler as the tuning element, for example. In some cases, the thermoelectric cooler may be a standard chip-sized thermoelectric cooler. It should be noted that only 5 waveguides 23 are shown for illustrative purposes, and there can be embodiments in which more or less waveguides are used. In general, the number of waveguides is similar to the number of elements in the detector array 24.

Temperature changes can be applied on the order of microseconds, which is more than three orders of magnitude faster than spectrometers that use free space optics and mechanical motion to achieve pixel shifting. In alternative embodiments, more than one temperature shift can be used to provide at least two states of operation resulting in a wavelength shift which will provide an even greater increase in the effective number of sample outputs N.

In an alternative embodiment, the refractive index of the on-chip dispersive element 22′ can be changed by applying an electric field, by applying a magnetic field, by changing the electron-hole concentration in the chip material, or by changing the local refractive index of the cladding around the dispersive element 22′. For example, a PN or PIN diode structure can be used to pass a current through the dispersive element 22′ to change the electron-hole concentration and hence change the refractive index through a material's plasma dispersion effect. In another example, a magnetic tuning element can be coupled to the dispersive element to apply a magnetic field to the dispersive element 22′ and hence change the refractive index through a material's magneto-optic effect. In yet another example, a capacitive structure can be used to apply an electric field to the dispersive element 22′ and hence change the refractive index through a material's electro-optic effect. In some embodiments, any of the refractive index tuning mechanisms described previously could apply to the cladding material around the dispersive element 22′ instead of the core material of the dispersive element, for example.

The application of electric fields, magnetic fields, or changing electron-hole concentrations can be done on a sub-nanosecond time scale, which is more than 7 orders of magnitude faster than spectrometers that use free-space optics and mechanical motion. In alternative embodiments, the electric and magnetic techniques described in the previous paragraph can be used to provide two or more shifts in wavelength which will provide an even greater increase in the effective number of sample outputs N.

It should be noted that more generally for the various embodiments according to the teachings herein, the tuning element, or another element, may be used to change a property of the spectrometer 20 in different states of operation in order to shift the plurality of narrowband optical signals in wavelength. In the example embodiment of FIGS. 3A and 3B, the property of the spectrometer 20 that is changed is the refractive index of the dispersive element 22′. However, in other embodiments, other properties of the spectrometer 20 may be changed such as, but not limited to, the path travelled by light signals by using a switch element to switch between different optical paths, or the angle of incidence of light signals on the dispersive element 22′ by using a switch element to switch between different optical paths, for example.

Referring now to FIG. 3C, shown therein is an experimental result of enhanced OCT imaging depth using an interpixel shift with the thermo-optic technique. In this example, the dispersive element is a PCG integrated on a silicon chip. The PCG is composed of a waveguide core of silicon nitride surrounded by a cladding of silicon dioxide. The PCG is designed with a central wavelength λ₀=860 nm and an output channel spacing δλ=0.068 nm/pixel, resulting in a Nyquist-limited imaging depth zₘₐₓ=2.7 mm in air.

The dotted lines in FIG. 3C show the resulting OCT images when the spectrometer is used in an SD-OCT system with a mirror in the sample arm measured at different depths, also known as an optical path difference (OPD) relative to the reference arm length. In FIG. 3C, images are overlaid when the mirror is located at OPD values of 1.5 mm to 3.25 mm in steps of 0.25 mm. For an OPD>zₘₐₓ, it can be seen that the OCT system is unusable because the images appear as artifacts at shorter OPD values due to Nyquist undersampling.

Experimental measurements showed that the PCG has a wavelength response versus temperature (also known as a thermo-optic coefficient) of approximately 0.01 nm/° C. resulting from a weighted average of the core and cladding thermo-optic coefficients. Therefore, a two-state interpixel shift technique should utilize a temperature shift of approximately ΔT=0.034 nm/0.01 nm/° C.=3.4° C. For example, the mirror can be set at an OPD=3.0 mm to represent a feature in a sample which exists at a depth beyond zₘₐₓ. The OCT system can implement a pixel shift technique by capturing an A-scan, increasing the PCG temperature by 3.3° C., capturing a second A-scan, interleaving the two data sets, and performing OCT processing on the combined data set. The resulting image is shown as the solid line in FIG. 3C which shows that the image is visible at an OPD=3.0 mm as expected, which is beyond the Nyquist limit of conventional OCT imaging. Accordingly, using this two-state interpixel shift, the effective zₘₐₓ is doubled to 5.4 mm. A small artifact is located at 2.4 mm, with an amplitude of −23 dB below the peak at 3.0 mm. This artifact is due to the temperature shift ΔT not being precisely the correct value, which indicates that accurate calibration of the temperature shift is important.

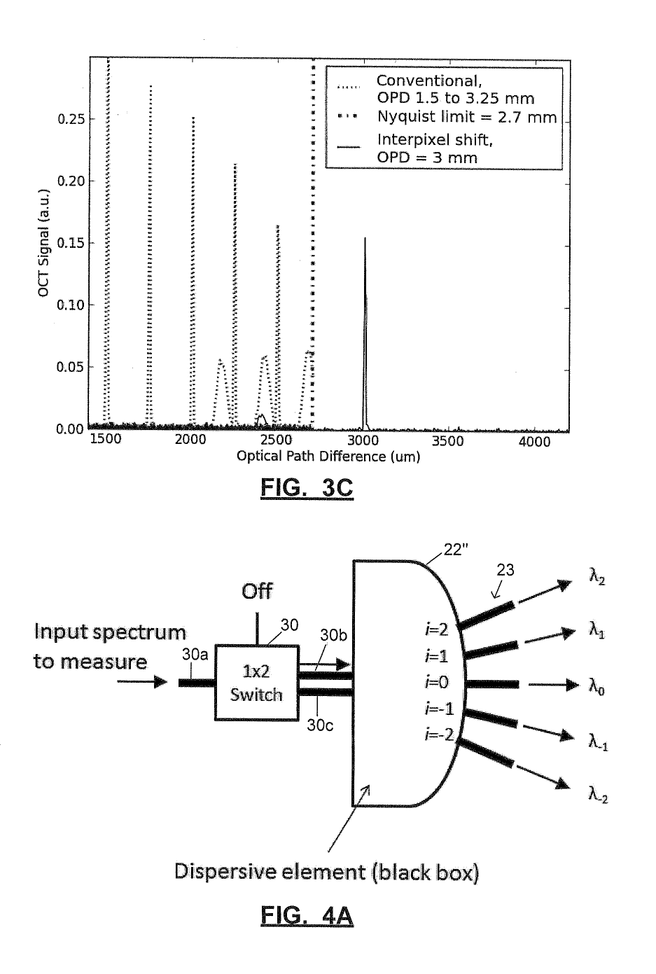

Referring now to FIGS. 4A and 4B, shown therein are schematic diagrams of a portion of an example embodiment of a spectrometer that is provided with one of first and second inputs to achieve State 1 and State 2 to achieve pixel-shifting. In this example embodiment, a switch element 30 is used to select between different inputs that will result in a wavelength shift in the output of the spectrometer. In this example, the switch element 30 can be implemented by using a 1×2 MEMS switch which has one input port 30a and two output ports 30b and 30c. In this case the dispersive element 22″ is designed so that when the input light signal is provided by the 2^{nd} output port 30b of the switch element 30, the output spectrum of the dispersive element 22″ is shifted with respect to the case when the input light signal is provided by the 1^{st} output port 30c of the switch element 30. The two inputs to the dispersive element 22″ (which are the two output ports 30b and 30c of the switch element 30) are positioned along an input to the dispersive element 22″ with a distance between them that results in the desired spectral shift Δλ between State 1 and State 2. In some embodiments, the two inputs to the dispersive element 22″ are positioned along an input focal curve to the dispersive element 22″ with a distance between them that results in the desired spectral shift Δλ between State 1 and State 2. In some embodiments, the wavelength shift occurs because the two switch output ports 30b and 30c direct the input light signal into the dispersive element 22″ at two different input angles, and the center wavelengths of the narrowband signals at the output of the dispersive element 22″ are dependent on the input angle of the light signal. In alternative embodiments, more than two output ports can be used for the switch element 30 to provide two or more shifts in wavelength which will provide an even greater increase in the effective number of sample outputs N.

In this example embodiment the switch element 30 is implemented on-chip. In an alternative embodiment, the switch element 30 can be implemented by using an interferometer-based device (actuated by a refractive index change as described above) that is on-chip, off-chip, or on a different chip. In another alternative embodiment, the switch element 30 can be an off-chip fiber-optic switch. In yet another alternative embodiment, the switch element 30 can be a mechanical switch that directs an optical fiber or waveguide to one of two output ports.

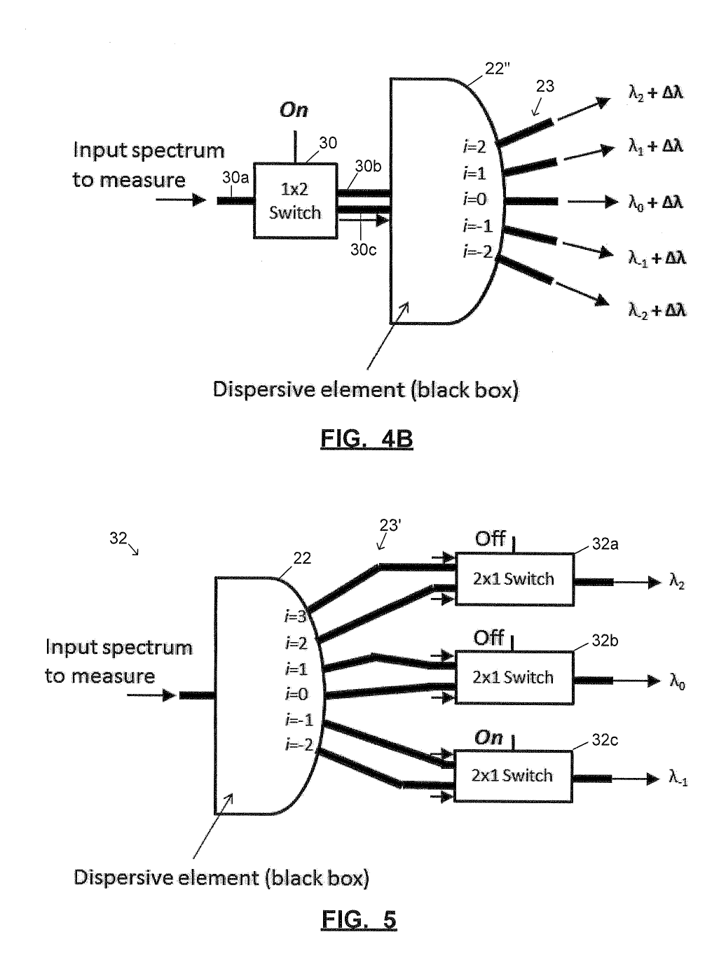

Referring now to FIG. 5, shown therein is a schematic diagram of a portion of an example embodiment of a spectrometer that uses a bank of output switch elements after the dispersive element to achieve State 1 and State 2 to achieve pixel-shifting. In this example embodiment, the input optical signal is broadband, the dispersive element 22 is a fixed element and the spectrometer comprises a bank 32 of output switch elements. It should be understood that only 3 output switch elements are shown for illustrative purposes and that more or less switch elements can be used. In general, the number of output switch elements is equal to the number of detector elements in the detector array 24.

In this case, the bank 32 of output switch elements is a series of 2×1 switches which select between adjacent outputs from the dispersive element 22. The adjacent outputs that are provided to the same switch element are offset by an amount Δλ by placement of the input ports of the waveguides 23′ along certain portions of the focal output of the dispersive element 22. The switch elements 32a, 32b, 32c can be operated to switch in the same manner or in any combination (which allows this spectrometer to shift a first part of the spectrum while leaving a second part of the spectrum fixed).

In the example embodiment of FIG. 5, the bank 32 of switch elements is located on chip. In an alternative embodiment, the bank 32 of switch elements can be implemented by using interferometer-based devices (that are actuated by a refractive index change as described previously). In another embodiment, the bank 32 of switch elements can be implemented by mechanical switches located on-chip or off-chip. In yet another embodiment, the bank 32 of switch elements can be fiber-optic switches.

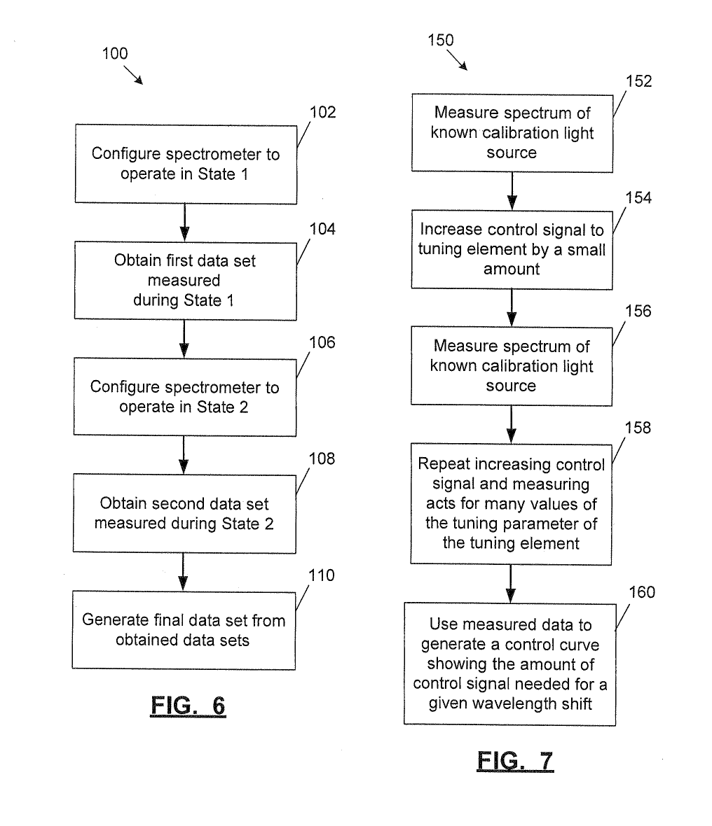

In a spectrometer that uses one of the various example embodiments described herein to implement pixel-shifting, the spectrometer may be implemented to function according to the pixel-shifting method 100 shown in FIG. 6. At 102, the spectrometer is configured to operate in State 1. At 104, a first data set corresponding to the measurement of the spectrum of an input optical signal during State 1 is obtained. At 106, the spectrometer is configured to operate in State 2 which employs a wavelength shift relative to that of State 1. At 108, a second data set corresponding to the measurement of the spectrum of the input optical signal is obtained. At 110, a final data set is generated from the data sets obtained during the different states of operation. In some embodiments of this case where there are two states, the final data set has double the data points of the first data set or the second data set and is generated by interleaving the data points from the first data set and the second data set. In alternative embodiments, additional processing may be used during 110 to improve the quality of the measured data. Such techniques could include, but are not limited to, applying numerical dispersion correction and averaging, for example.

In alternative embodiments, the spectrometer can be configured to operate in additional states to obtain additional data sets that are then combined to form the final data set. Accordingly, a set of configuring and obtaining acts can be added to the method 100 for each additional state that the spectrometer is configured to operate in.

For the various pixel-shifting embodiments described herein, calibration and control schemes may also be used to ensure accurate operation. For example, for the pixel-shifting embodiment shown in FIGS. 2A-2B, the elements used to achieve the wavelength shift Δλ are preferably accurate to within less than 10% error and in some cases to within less than 1% error so that the combined data set generated from the data sets obtained during the different states of operation have components that are substantially equally spaced in wavelength or wavenumber, as the case may be. Calibration and/or feedback control, which depends on the particular implementation including the materials that are used, can be used to achieve the required accuracy as will now be described.

For the case in which the wavelength-shifting properties of an element are constant over the life of the element, then a pre-calibration of the spectrometer may be sufficient to ensure reliability and accuracy. An example embodiment of a calibration method 150 is shown in FIG. 7. At 152, the spectrum of a known calibration light source is measured. At 154, the control signal to the tuning element is increased in amplitude (e.g. stepped) by a small amount. At 156, the spectrum is measured again. At 158, the control signal increase and measuring acts are repeated for many values of the tuning parameter of the tuning element. For example, the control signal can be an analog voltage or an analog current that is applied to a heater to vary the tuning parameter in the case of temperature tuning. At 160, curve-fitting can be performed on the measured data to calculate a control curve that shows the amount of wavelength shift versus the control signal. From the control curve, one can calculate the amount of reference control signal that is needed to achieve a desired wavelength shift in the spectrometer.

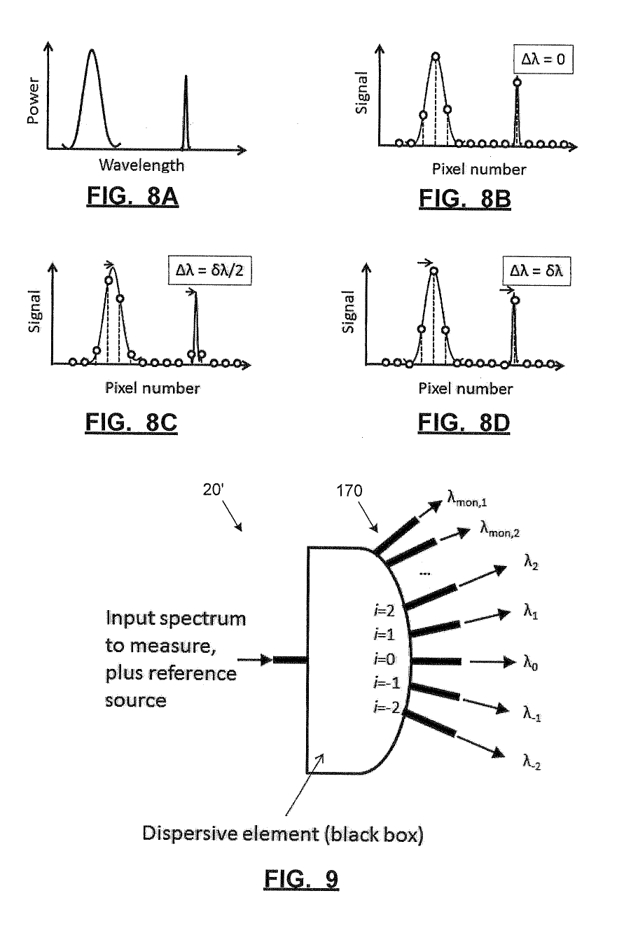

The calibration procedure is shown graphically in FIGS. 8A-8D. FIG. 8A shows the spectrum of a reference calibration light source. The dots in FIGS. 8B-8D show the spectrometer output values versus pixel number as the amount of wavelength shift Δλ is increased by increasing the amplitude of the control signal to the tuning element. It can be seen that the reference wavelength shifts to the right and there is a spacing of δλ between the pixels in FIG. 8D compared to no shift in FIG. 8B.

For the case in which the wavelength-shifting properties of an element of the spectrometer can vary or degrade over time, then a control loop may be required to monitor the wavelength shifting process during operation. For instance, a thermal sensor can be used at a portion of the spectrometer where temperature is being used to achieve the pixel-shift in order to generate a feedback signal proportional to the temperature change. In some embodiments, the thermal sensor can be a thermistor that is attached to the portion of the chip where temperature is being controlled. Alternatively, in some embodiments, a thin film temperature-sensing element can be integrated onto the portion of the chip where temperature is being controlled. The feedback signal is used to increase or decrease the control signal to ensure that the correct amount of temperature change (based on measurements during calibration) is being applied to place the spectrometer in the different desired states during operation.

In an alternative, the optical output ports of a spectrometer 20′ can be used to generate a feedback control loop irrespective of the tuning method (e.g. thermo-optic, electro-optic, etc.) that is used to implement the pixel-shift. In some embodiments, a stable reference light source of known wavelength (referred to as a reference wavelength) can be continuously injected into the spectrometer 20′, outside of the normal operating bandwidth of the spectrometer 20′ to eliminate interference. The light from the reference light source can be directed to two or more outputs of the spectrometer 20′ that act as monitors and are designed to receive the reference wavelength of light from the reference light source. The monitor outputs are measured in the various states of operation and used to generate a feedback signal that controls the magnitude of the control signal. This scheme is shown in FIG. 9, in which the waveguide array 170 contains two output waveguides that act as monitors and are configured to receive the reference wavelengths λ_{mon,1} and λ_{mon,2}.

In another alternative, there can be some embodiments which do not use a reference light source to generate a feedback signal for controlling the amount of pixel-shifting. In this case, one or more output waveguides of the spectrometer 20′ can be used as monitors, as was shown in FIG. 9, and are designed such that the intensity of transmitted light is dependent on the wavelength of the propagating light. The monitors can be connected to a photonic device placed in between the dispersive element 20 and the detector array 24. The transfer function of the photonic device is dependent on the wavelength of the light coming out of the dispersive element 20. Various photonic devices can be used here such as, but not limited to, directional couplers, gratings, and ring resonators, for example. In some embodiments, a feedback signal from a temperature sensor, such as a thermistor, may be used in conjunction with the feedback signals from the monitors to cancel out any global temperature induced variations on the photonic device.

For pixel-shifting embodiments which use a switch to help achieve the pixel-shift, such as the embodiments shown in FIGS. 4A, 4B and 5, the switch may preferably be a digital optical switch where all of the light is transferred to a certain port when the control signal to the switch crosses a threshold value, regardless of how far the control signal is above or below the threshold value. This is also referred to as a step-like transfer function. This type of a digital switch is much more tolerant to noise or drift of the control signal and only a simple calibration may be used to determine the threshold value. Furthermore, it is preferable that the embodiment shown in FIG. 5 use switches that operate in a digital manner due to the complexity of individually calibrating many tens, hundreds or thousands of switches, depending on the particular implementation.

For embodiments which use an analog switch to help achieve the pixel-shift, a specific analog control value may be applied. Furthermore, calibration and/or control techniques may be used as discussed previously. For example, if temperature tuning is used to actuate the pixel-shift, then a local thermistor integrated on the chip may be used to generate a feedback signal. Alternatively, the feedback signal may be generated from optical monitors of the spectrometer 20′ as previously described. Accordingly, it can be seen that a digital switch results in a much easier calibration and operation than an analog switch.

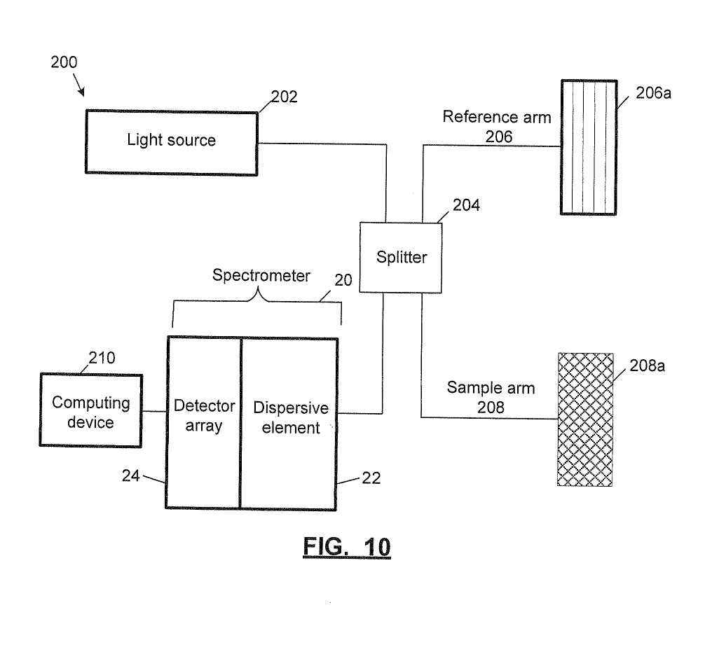

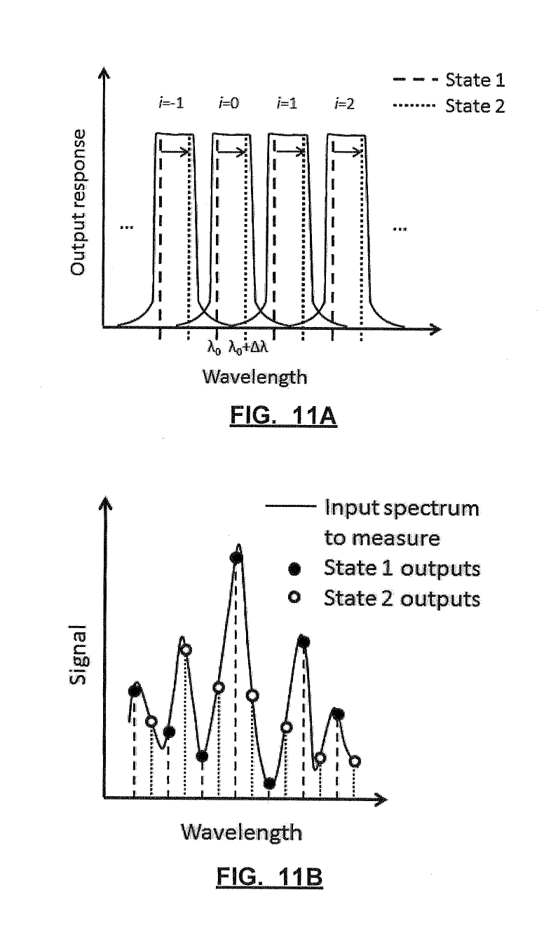

Referring now to FIG. 10, shown therein is an example use of the spectrometer 20 in an example embodiment of an SD-OCT system 200. In general, the SD-OCT system 200 comprises a light source 202, a splitter 204, a reference arm 206, a reference element 206a, a sample arm 208 that leads to a sample 208a, the spectrometer 20, the dispersive element 22, the detector array 24, and a computing device 210. The SD-OCT system 200 is implemented such that one or more components are integrated on a planar substrate (i.e. on an integrated chip). In some cases, all of the components are integrated on the chip. In other cases, not all of the components need be located on the same chip. However, at least the dispersive element 22 is preferably located on-chip.

The light source 202 generates an optical signal that is generally broadband in terms of wavelength. The light source 202 can be implemented by one of a superluminescent diode, a fiber amplifier, a femtosecond pulsed laser, a supercontinuum source, an optical parametric oscillator, a frequency comb, or any other broadband source or near infrared light source, that may be suitable given the use of the SD-OCT system 200. In some embodiments, the light source 202 may be tunable which means that the light source 202 can be set or controlled to output one or more predetermined wavelengths of light. This allows the OCT system 200 to be configured such that one or more specific wavelengths of light can be selected and/or predetermined for use in analyzing the sample 208a.

The splitter 204 is a beam splitter that splits the optical signal into two beams (i.e. first and second portions of the optical signal) to generate a reference beam for the reference arm 206 and a sample beam for the sample arm 208. In some embodiments, the splitter 204 can have a broad bandwidth and can operate with a flat 50:50 splitting ratio for all wavelengths of interest, which can tend to provide low optical signal losses. Alternatively, in some embodiments, the splitter 204 can have a splitting ratio other than 50:50 to improve the quality of the interference signal generated from the light signals provided by the reference arm 206 and the sample arm 208 to the spectrometer 20. The splitter 204 can be one of a y-splitter, a multimode interference splitter, a directional coupler, a Mach-Zehnder splitter or other optical beam splitter capable of splitting a received optical signal into split optical signals and directing the split optical signals towards two or more optical pathways.

The reference arm 206 receives the first portion of the optical signal and directs this signal towards the reference element 206a which reflects the first portion of the optical signal. The reflected first portion of the optical signal is sent to the spectrometer 20 by the splitter 204. Accordingly, the reference arm 206 introduces a delay that allows, for example, depth analysis of the sample 208a when the reflected first portion of the optical signal is delayed by a known path length equal to the depth of the sample 208a at a particular point of interest for imaging.

The sample arm 208 receives the second portion of the optical signal and directs this signal toward the sample 208a which reflects the second portion of the optical signal. The reflected second portion of the optical signal is sent to the spectrometer 20 by the splitter 204. The reflected second portion of the optical signal can be used, in combination with the optical signal from the reference arm, to generate a surface or sub-surface image of the sample 208a.

The reference arm 206 and the sample arm 208 can be implemented using free-space optical components, fiber optic components, or integrated optic components by one or more waveguides having an effective refractive index. In some embodiments, at least one of the reference arm 206 and the sample arm 208 can be comprised of materials that are transparent in the wavelength range of the optical signal provided by the light source 202, such as silicon, silicon nitride, doped glass, other polymers or suitable materials for guiding light in a wavelength range of interest, depending on the use of the SD-OCT system 200.

In some embodiments, the reference element 206a can be a controllable delay element that is configured to adjust the refractive index of a portion of the reference arm 206 to introduce the delay. In some embodiments, the controllable delay element can adjust the refractive index of the reference arm 206 by changing the temperature of a portion of the reference arm 206. In alternative embodiments, the controllable delay element can adjust the refractive index of the reference arm 206 by employing the electro-optic effect. In some embodiments, the reference element 206a can have a serpentine shape and a path length comparable to the path length of the sample arm 208 in order to provide the delay.

The optical signals from the reference arm 206 and the sample arm 208 are combined by passing either through the same optical element which initially split the two signals, or by passing through a recombiner (not shown). Accordingly, in this example embodiment the splitter 204 is used to recombine the optical signals from the reference arm 206 and the sample arm 208, however, other elements may be used in other embodiments to implement the recombiner.

The spectrometer 200 generates a spectral interferogram by generating output samples representative of the interference between the reflected first and second portions of the optical signal as a function of wavelength. The measured data is then sent to the computing device 210 where the data is processed to generate an OCT image.

The dispersive element 22 receives the reflected first and second portions of the optical signal and generates a dispersed spectrum along an output focal curve which is representative of the spectrum of the interference signal (i.e. of the interference between the reflected first and second portions of the input optical signal). The dispersive element 22 can be implemented by an Arrayed Waveguide Grating (AWG) or a Planar Concave Grating (PCG), for example.

The remaining description of the dispersive element 22, the detector array 24 and in some cases a waveguide array were previously explained in the description of FIG. 1 and will not be repeated here.

The computing device 210 receives the measured data from the spectrometer 20 and processes the measured data by using a processing algorithm to produce processed data in a certain format. For example, when the measured data corresponds to a plurality of narrowband optical signals that are linearly spaced in wavelength then the computing device 210 can use an interpolating algorithm to process the data and generate interpolated data that is equally spaced in wavenumber. The computing device 210 can then use an inverse Fourier transform to analyze the set of interpolated narrowband optical signals to obtain the OCT image of the sample.

In some embodiments, special arrangements may be used such that the measured data provided to the computing device 210 corresponds to a plurality of narrowband optical signals that are linearly spaced in wavenumber. In these cases, the computing device 210 can apply an inverse Fourier transform on the data directly without requiring interpolation.

The computing device 210 can be implemented by any suitable processor in a desktop computer, laptop, tablet, smart phone, or any other suitable electronic device. Alternatively, the computing device 210 can be implemented using dedicated hardware or an Application Specific Integrated Circuit (ASIC).

In another example embodiment, the spectrometer 20 can be used with a light source that is tunable and the spectrometer 20 is fixed, and the light source can be used to achieve pixel-shifting. This can for example be used in the OCT system 200 as well as other applications. The term “fixed” means that the optical properties of the components of the spectrometer 20 are not meant to vary during operation. In this example embodiment, the light source can be a frequency comb instead of a broadband source in order to provide a comb of discrete wavelengths. For example, the frequency comb can be generated by an optical parametric oscillator (OPO), by a mode-locked laser, or by amplitude modulation of a continuous wave laser. In this example, the spectrometer 20 may be designed to have pass bands which are substantially flat with respect to wavelength. In this case, the spectrometer 20 is changed from State 1 to State 2 by altering the frequency comb of the light source to provide a shift in the output wavelengths of the spectrometer 20 (in other words, a shift in wavelength in the output of the spectrometer 20). This can be accomplished by refractive index tuning (as described above) of the light source. In this case, the frequency comb results in output signals that are equally spaced in frequency (e.g. wavenumber) which is useful in certain applications such as OCT, for example. At least the dispersive element 22 of the spectrometer 20 is implemented on a planar substrate. The light source can be implemented on a planar substrate. In some cases the light source may be on the same planar substrate as the dispersive element 22 and in other embodiments on a different planar substrate. In some embodiments, the light source is off-chip.

Referring now to FIGS. 11A and 11B, shown therein are example graphs illustrating the operation of a tunable light source and a fixed spectrometer to achieve pixel-shifting. FIG. 11A shows spectral transmission plots for each output port of the spectrometer (solid line) and comb wavelengths in State 1 (dashed) and State 2 (dotted). Each dashed or dotted line shows the wavelength of one comb line from the tunable light source. FIG. 11B shows an example of the spectrum to be measured and the sampled wavelengths in State 1 (dashed) and State 2 (dotted).

In another embodiment, to implement pixel-shifting, the tunable source and the spectrometer could be shifted at the same time so that the bandpass of each output of the dispersive element substantially overlaps with one of the frequency comb components from the light source.

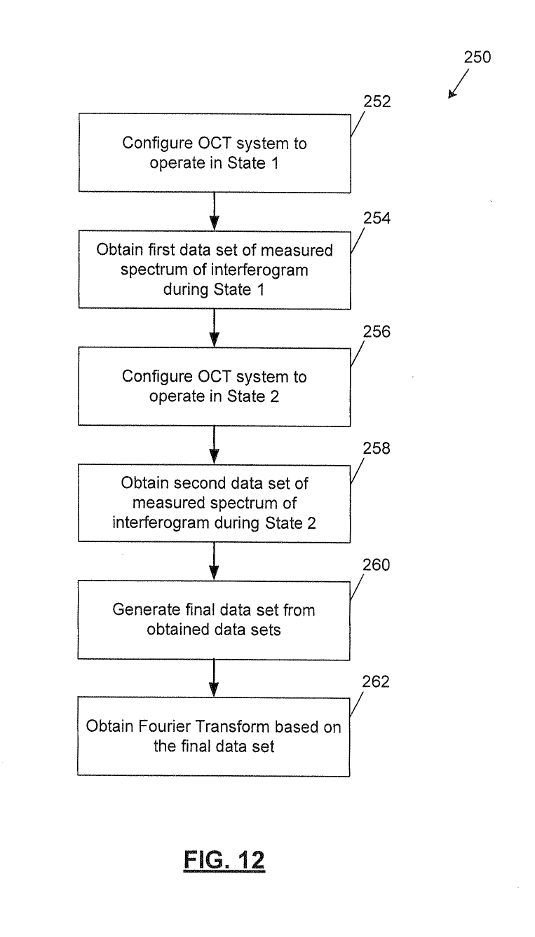

In a complete OCT system that uses one of the various example embodiments described herein to implement pixel-shifting, the complete OCT system can be implemented to function according to the pixel-shifting OCT method 250 shown in FIG. 12. At 252, the OCT system is configured to operate in State 1. At 254, a first data set corresponding to the measurement of the spectrum of the interferogram during State 1 is obtained. At 256, the OCT system is configured to operate in State 2. At 258, a second data set corresponding to the measurement of the spectrum of the interferogram during State 2 is obtained. At 260, a final data set is generated from the data sets obtained during the different states of operation. In some embodiments of this case where there are two states, the final data set has double the data points of the first data set or the second data set and is generated by interlacing the data points from the first data set and the second data set. Alternatively, other techniques may be used for combining the first and second data sets which may depend on the wavelength or frequency spacing in the first and second data sets. At 262, an inverse Fourier transform on the final data set is performed. In alternative embodiments, additional processing may be used during 260 to improve the quality of the spectral estimate. Such techniques could include, but are not limited to, applying a Gaussian spectral window, applying numerical dispersion correction, and averaging, for example.

In alternative embodiments, the OCT system can be configured to operate in additional states to obtain additional data sets that are then combined to form the final data set. Accordingly, a set of configuring and obtaining acts can be added to the method 100 for each additional state that the OCT system is configured to operate in.

With regards to the various embodiments described herein, various elements of those embodiments may be composed of waveguides formed on a planar substrate. In some embodiments, these waveguides can be comprised of materials that are transparent in the near infrared spectrum in the ranges typically used in spectrometers or OCT systems, such as, but not limited to, 850 nm, 1050 nm or 1310 nm spectral bands. However, it should be understood that in other embodiments alternative materials can be chosen that are appropriate for another particular wavelength or range of wavelengths of light. In some embodiments, the materials used to form waveguides have a high refractive index contrast, such as a core to cladding ratio of 1.05:1 or greater, for example, which can confine light and enable more compact photonic components as compared to materials having a low refractive index contrast. In some embodiments, waveguides can be comprised of silicon nitride, silicon oxynitride, silicon, SU8, doped glass, other polymers or another suitable material.

In some embodiments, the elements of the embodiments can be formed on a planar substrate using photolithography. However, it should be understood that photonic circuits can be fabricated by other methods, such as, but not limited to, electron beam lithography, for example.

In embodiments where elements are formed on a planar substrate using photolithography and where waveguides and other photonic elements on the planar substrate are silicon nitride, a standard silicon wafer can be used having several microns of silicon dioxide thermally grown on a top surface as a lower waveguide cladding. In some embodiments, a thickness of 3-4 microns of silicon dioxide can be used. However, it should be understood that other thicknesses can be used and may be appropriately chosen based on the wavelength range of input optical signals to be analyzed and/or processed. In some embodiments, silicon dioxide can be deposited by other techniques such as, but not limited to, plasma enhanced chemical vapor deposition, for example. In some embodiments, a material other than silicon dioxide may be used for a lower cladding.

Silicon nitride can then be deposited onto the planar substrate, and in some embodiments, a few hundred nanometers of stoichiometric silicon nitride can be deposited using low pressure chemical vapor deposition. An anti-reflection coating layer such as Rohm and Haas AR3 can additionally be applied by spin coating onto the planar substrate, which can enhance the performance of the photolithography process. A UV-sensitive photoresist such as Shipley UV210 can then be applied by spin coating onto the planar substrate.

The planar substrate can be patterned using a photolithographic patterning tool at an appropriate exposure to expose the resist with a pattern of waveguides and other devices. After being exposed, the planar substrate can be developed with a suitable developer process, such as MicroChemicals AZ 726MIF to remove unexposed resist. A descum process can be used with a plasma etcher to remove residual resist and the pattern in the resist can be reflowed for several minutes, in some embodiments, with a hot plate to smooth out any surface roughness.

The silicon nitride on the planar substrate can be etched using inductively coupled reactive ion etching (ICP RIE) with a CHF₃/O₂ recipe. The resist mask used for etching can then be removed in an oxygen plasma or in a hot strip bath which contains heated solvents.

In some embodiments, the planar substrate can be annealed in a furnace oxide tube at 1,200° C. for three hours. This can tend to reduce material absorption losses in embodiments where an optical source generates an optical signal at wavelengths that are near infrared.

The planar substrate can then be covered in oxide, in some embodiments, using high temperature oxide deposited in furnace tubes or by plasma enhanced chemical vapor deposition. The planar substrate can then be diced and the end facets can be polished which can improve coupling of waveguides and other optical elements formed on the planar substrate. Alternatively, the end facets can be lithographically defined and etched using a deep reactive-ion etching process such as the Bosch process, for example.

It should be noted that there may be variations to the fabrication techniques described above depending on the particular embodiment of the spectrometer that is being manufactured and/or the particular use of the spectrometer.

It should further be noted that in an alternative embodiment, the array of waveguides could be implemented in a non-planar arrangement such as waveguides written in a 3D pattern by laser writing in a photosensitive material. In yet another embodiment, the array of waveguides could be implemented by an array of optical fibers.

It should be noted that the various example embodiments described herein have generally been described to implement two different states of operation which results in output data that are shifted by ½ pixel to double the dispersion, which increases the spectral resolution of the output data and, in the example application of OCT, the imaging depth. However, other combinations of states are also possible to implement different amounts of pixel-shifts. For example, three states can be used which are offset by ⅓ of a pixel to triple the dispersion. As another example, four states can be used which are offset by ¼ of a pixel to quadruple the dispersion. As a further example, five states can be used which are offset by ⅕ of a pixel to quintuple the dispersion and so on and so forth. In principle any desired number of states may be used to increase the dispersion. A practical limit may be reached when the time spent switching between states becomes impractical for a given application, or when the switching amount Δλ becomes significantly less than the line-width or resolution at the dispersive element output.

It should also be noted that the various example embodiments described herein can be implemented to facilitate discrete measurements when the spectrometer is set to different discrete states. However, in alternative embodiments, the various example embodiments described herein can be implemented to take continuous measurements as the spectrometer system transitions between an initial state and a final state.

It should also be noted that the various example embodiments described herein are described as using waveguides 23, 23′ to couple the outputs of the dispersive element 22 or the outputs of the bank of output switch elements 32 to the detector array 24. Alternatively, each of the example embodiments described herein can be implemented such that the outputs from the dispersive element 22 or the outputs of the bank of output switch elements 23, 23′ can be directly focused onto the detector array 24 without the use of waveguides.

The various pixel-shifting embodiments described herein that implement pixel-shifting are generally inexpensive, small, robust and simple to fabricate. In general, standard IC fabrication techniques can be used to fabricate the integrated components that are used in the various pixel-shifting embodiments described herein. Accordingly, at least some of the various pixel-shifting embodiments described herein can easily be integrated on a chip as well as integrated with other on-chip components. Furthermore, the various pixel-shifting embodiments described herein allow the detector array 24 to be implemented with fewer pixels due to the increase in effective number of sample outputs N, which can dramatically reduce the overall system cost in some situations. For example, a detector array with 512 pixels can be used instead of a detector array with 1024 pixels when the spectrometer system is operated in two different states of operation.

At least some of the elements of the various OCT embodiments described herein, such as the computing device 26, may be implemented via software and written in a high-level procedural language such as object oriented programming or a scripting language. Accordingly, the program code may be written in C, C⁺⁺ or any other suitable programming language and may comprise modules or classes, as is known to those skilled in object oriented programming. Alternatively, at least some of the elements that are implemented via software may be written in assembly language, machine language or firmware as needed. In either case, the program code can be stored on a storage media or on a computer readable medium that is readable by a general or special purpose programmable computing device having a processor, an operating system and the associated hardware and software that is necessary to implement the functionality of at least one of the embodiments described herein. The program code, when read by the computing device, configures the computing device to operate in a new, specific and predefined manner in order to perform at least one of the methods described herein.

While the above description provides examples of various embodiments, it will be appreciated that some features and/or functions of the described embodiments are susceptible to modification without departing from the principles of operation of the described embodiments. Accordingly, what has been described above has been intended to be illustrative of the subject matter described herein and non-limiting and it will be understood by persons skilled in the art that other variants and modifications may be made without departing from the scope of the claimed subject matter as defined in the claims appended hereto. Furthermore, the scope of the claims should not be limited by the preferred embodiments and examples, but should be given the broadest interpretation consistent with the description as a whole.

1. A spectrometer comprising:
a dispersive element configured to generate a plurality of spatially separated spectral components from a received optical signal, the dispersive element being fabricated on a chip;
a detector array coupled to the dispersive element to capture a plurality of narrowband optical signals from the plurality of spatially separated spectral components and generate output samples thereof; and
a tuning element configured to change a property of the spectrometer in different states of operation in order to shift the plurality of narrowband optical signals in wavelength to increase an effective number of output samples generated by the detector array when the spectrometer is used in more than one state of operation.

2. The spectrometer of claim 1, wherein the tuning element is a heating element that creates a refractive index shift in the dispersive element by changing a temperature of the dispersive element by an appropriate amount to achieve a desired wavelength shift.

3. The spectrometer of claim 2, wherein the heating element comprises a localized integrated heating element or a thermoelectric cooler.

4. The spectrometer of claim 1, wherein the tuning element is configured to apply one of an electric field, a magnetic field or a change in electron-hole concentration to the dispersive element to create a refractive index shift in the dispersive element in order to shift the plurality of narrowband optical signals in wavelength.

5. The spectrometer of claim 1, wherein the tuning element is configured to change a local refractive index of a cladding around the dispersive element to create a refractive index shift in the dispersive element in order to shift the plurality of narrowband optical signals in wavelength.

6. The spectrometer of claim 1, wherein the tuning element comprises a switch element having an input port and at least two output ports, the switch element being controlled to transmit a received optical signal to the dispersive element through one of the output ports; wherein, in use, the output port of the switch element that transmits light to the dispersive element is switched in at least one state of operation in order to achieve the wavelength shift of the plurality of narrowband optical signals.

7. The spectrometer of claim 6, wherein the at least two output ports are positioned along an input to the dispersive element to have a desired distance there between to achieve the wavelength shift.

8. The spectrometer of claim 1, wherein the tuning element comprises a bank of output switch elements having several input ports and one output port, the bank of output switch elements being coupled to the dispersive element to capture a plurality of narrowband optical signals from the plurality of spatially separated spectral components, each output switch element being controlled to transmit a narrowband optical signal in one of the input ports to the detector array through the output port and in use, the input port of at least one output switch element selected to transmit light to the detector array is switched in at least one state of operation in order to achieve the wavelength shift of the plurality of narrowband optical signals.

9. The spectrometer of claim 8, wherein the bank of output switch elements are located along an output of the dispersive element so that adjacent outputs of the dispersive element that are provided to a common switch element are offset by the wavelength shift.

10. The spectrometer of claim 8, wherein the bank of output switch elements comprise a series of M×1 switches which select between outputs from the dispersive element offset by a desired wavelength shift.

11. The spectrometer of claim 8, wherein each series of output switch elements is switched in the same manner during different states of operation.

12. The spectrometer of claim 8, wherein each series of output switch elements can be switched in various combinations to switch all or some of the narrowband optical signals generated by the dispersive element.

13. The spectrometer of claim 1, wherein the tuning element comprises at least one switch element, the at least one switch element comprising at least one of an on-chip MEMS switch, an off-chip fiber-optic switch, or an interferometer-based device that can be controlled to have a refractive index change by using the material thermo-optic effect, an electric field, a magnetic field, or a change in electron-hole concentration, the interferometer-based device being located on-chip, off-chip, or on a different chip with respect to the dispersive element.

14. The spectrometer of claim 1, wherein the dispersive element is one of an Arrayed Waveguide Grating (AWG) or a Planar Concave Grating (PCG).

15. The spectrometer of claim 1, wherein at least one of calibration and a feedback signal are used to control the shift in wavelength.

16. An optical measurement system comprising:
a tunable light source comprising a frequency comb configured to provide an optical signal having a comb of discrete wavelengths;
a splitter coupled to the tunable light source, the splitter configured to split the optical signal into first and second portions;
a reference arm coupled to the splitter to receive the first portion of the optical signal and provide a reference optical signal back to the splitter;
a sample arm coupled to the splitter to receive the second portion of the optical signal and provide a sample optical signal to the splitter;
a spectrometer coupled to the splitter to receive an interference signal resulting from a combination of the reference optical signal and the sample optical signal and generate output samples representative of the spectrum of the interference signal, at least a dispersive element of the spectrometer being located on a chip; and
a computing device coupled to the spectrometer to receive the output samples and generate an inverse Fourier transform of the interference signal based on the output samples,
wherein, in use, the measurement system is operated in a first state and at least one additional state by configuring the tunable light source to alter the frequency comb to provide a shift in wavelength in the output of the spectrometer thereby increasing an effective number of output samples generated by the spectrometer when the spectrometer is used in more than one state of operation.

17. The system of claim 16, wherein the tunable light source is configurable to alter the frequency comb by using refractive index tuning.

18. The system of claim 17, wherein the refractive index tuning is accomplished by applying one of a temperature change, an electric field, a magnetic field or a change in electron-hole concentration to the tunable light source.

19. The system of claim 16, wherein the dispersive element is one of an Arrayed Waveguide Grating (AWG) or a Planar Concave Grating (PCG).

20. The system of claim 16, wherein at least one of calibration and a feedback signal are used to control the shift in wavelength.

21. A method of increasing output data samples from a spectrometer, wherein the method comprises:
configuring the spectrometer to operate in a first state by configuring a tuning element to change a property of the spectrometer, the spectrometer being fabricated on a chip;
obtaining a first data set corresponding to the measurement of a spectrum of a first input optical signal during the first state;
configuring the spectrometer to operate in a second state in which one of input optical signals to the spectrometer or output optical signals from the spectrometer are shifted in wavelength compared to the first state;
obtaining a second data set corresponding to the measurement of a spectrum of a second input optical signal during the second state; and
generating a final data set from the data sets obtained during the states.

22. The method of claim 21, wherein the spectrometer is used in an Optical Coherence Tomography (OCT) system and the method further comprises processing the final data set to obtain an OCT image.

23. The method of claim 22, wherein the input optical signals to the spectrometer are shifted in wavelength by using a tunable light source for the OCT system and altering a frequency comb of the tunable light source in at least one of the states of operation.

24. The method of claim 21, wherein the input optical signals to the spectrometer are shifted in wavelength by using a switch element that is switchable to provide one of two input optical signals to a dispersive element of the spectrometer and switching the switch element in at least one of the states of operation.

25. The method of claim 21, wherein the output optical signals from the spectrometer are shifted in wavelength by changing a refractive index of a dispersive element of the spectrometer in at least one of the states of operation.

26. The method of claim 21, wherein the output optical signals from the spectrometer are shifted in wavelength by using a bank of a series of output switch elements each having several input ports that are switchable and coupled to a dispersive element of the spectrometer, and switching the input ports on at least one output switch element in at least one of the states of operation.

27. The method of claim 21, wherein the method further comprises using at least one of calibration and a feedback signal to control the shift in wavelength.
